(19) United States
(12) Patent Application Publication
(10) Pub. No.: US 2015/0087430 A1
(43) Pub. Date: Mar. 26, 2015

(54) SERIES-TO-PARALLEL DAMPER ASSEMBLY INCLUDING TWO FLANGES

(71) Applicant: Schaeffler Technologies GmbH & Co. KG, Herzogenaurach (DE)

(72) Inventor: Victor NORWICH, Columbus, OH (US)

(21) Appl. No.: 14/494,152

(22) Filed: Sep. 23, 2014

Related U.S. Application Data
(60) Provisional application No. 61/881,796, filed on Sep. 24, 2013.

(51) Int. Cl. F16F 15/121; F16D 33/18

(52) U.S. Cl. CPC F16F 15/1213; F16D 33/18
USPC 464/68.9

(57) ABSTRACT

A damper assembly for a torque converter is provided. The damper assembly includes a first cover plate; a second cover plate, the first cover plate and second cover plate supporting springs therebetween; a first flange between the first cover plate and the second cover plate; and a second flange between the first cover plate and the second plate, the first flange and second flange being arranged with respect to the first and second cover plates and the springs such that the springs transition during operation of the damper assembly from initially operating in series to operating in parallel.

This claims the benefit to U.S. Provisional Patent Application No. 61/881,796, filed on Sep. 24, 2013, which is hereby incorporated by reference herein.

The present disclosure relates generally to torque converters and more specifically to damper assemblies for torque converters.

### BACKGROUND

U.S. Pat. No. 7,658,679 discloses a series-parallel damper assembly.

### SUMMARY OF THE INVENTION

A damper assembly for a torque converter is provided. The damper assembly includes a first cover plate; a second cover plate, the first cover plate and second cover plate supporting springs therebetween; a first flange between the first cover plate and the second cover plate; and a second flange between the first cover plate and the second plate, the first flange and second flange being arranged with respect to the first and second cover plates and the springs such that the springs transition during operation of the damper assembly from initially operating in series to operating in parallel.

A torque converter is also provided. The torque converter includes the damper assembly and a turbine connected to the damper assembly.

### BRIEF DESCRIPTION OF THE DRAWINGS

The present invention is described below by reference to the following drawings, in which:

FIG. 1 shows cross-sectional side view of a torque converter for a motor vehicle drive train including a damper assembly in accordance with an embodiment of the present invention;

FIGS. 2a and 2b are exploded perspective views of the damper assembly;

FIGS. 3a to 3d each show two views illustrating the operation of the damper assembly; and

FIG. 4 shows a damper assembly in accordance with another embodiment of the present invention.

### DETAILED DESCRIPTION

The present disclosure provides an embodiment of a multi-stage damper which, when compared to a conventional damper using the same springs and overall envelope, is capable of providing the same capacity while providing a multi-stage design with greater overall travel and reduced rates. Such conventional series to parallel dampers are more complex, expensive and space consuming. By adding a second flange to a first flange, the multi-stage damper creates two dampers within a single envelope, allowing the first and second flanges to create two to three primary spring stages, initially working in series and finally transitioning to parallel operation.

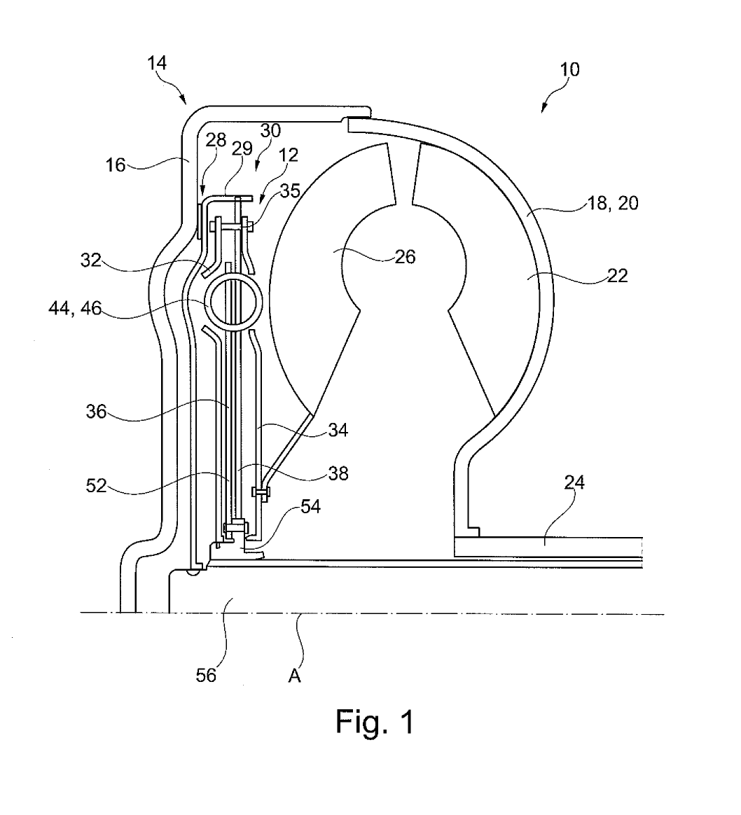

FIG. 1 shows cross-sectional side view of a torque converter 10 for a motor vehicle drive train including a damper assembly 12 in accordance with an embodiment of the present invention. Torque converter 10 includes a cover 14 including a front cover 16 for connecting to a crankshaft of an internal combustion engine and a rear cover 18 forming a shell 20 of an impeller 22. Impeller shell 20 is nonrotatably fixed to a hub 24. Torque converter 10 also includes a turbine 26 that is connected to damper assembly 12 and a lockup clutch 28 for rotationally connecting damper assembly 12 with front cover 16. Lockup clutch 28 includes a piston 29 that is axially movable toward and away from front cover 16 to rotationally engage damper assembly 12 with and rotationally disengage damper assembly 12 from front cover 16. Lockup clutch 28 is rotationally coupled to damper assembly 12. More specifically, piston 29 of lockup clutch 28 is rotationally connected to a second flange 38 of damper assembly 12.

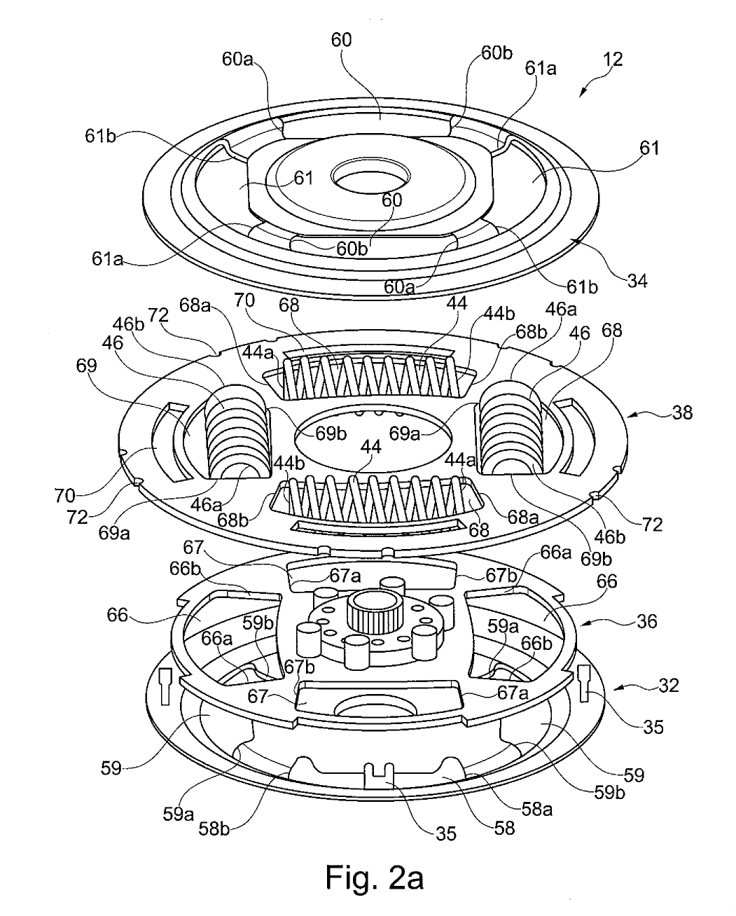

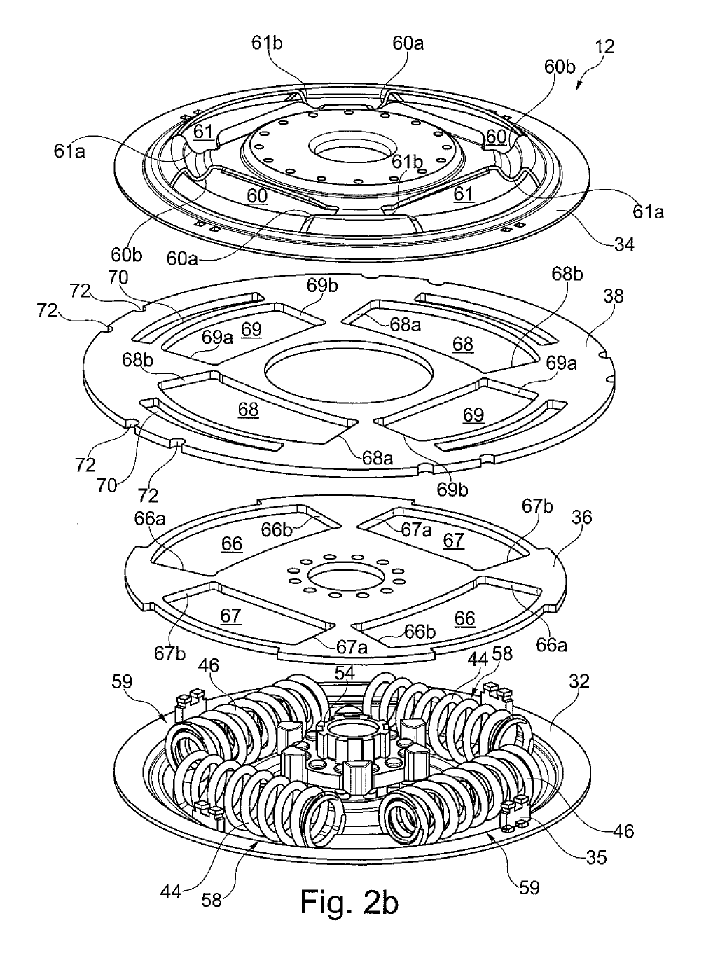

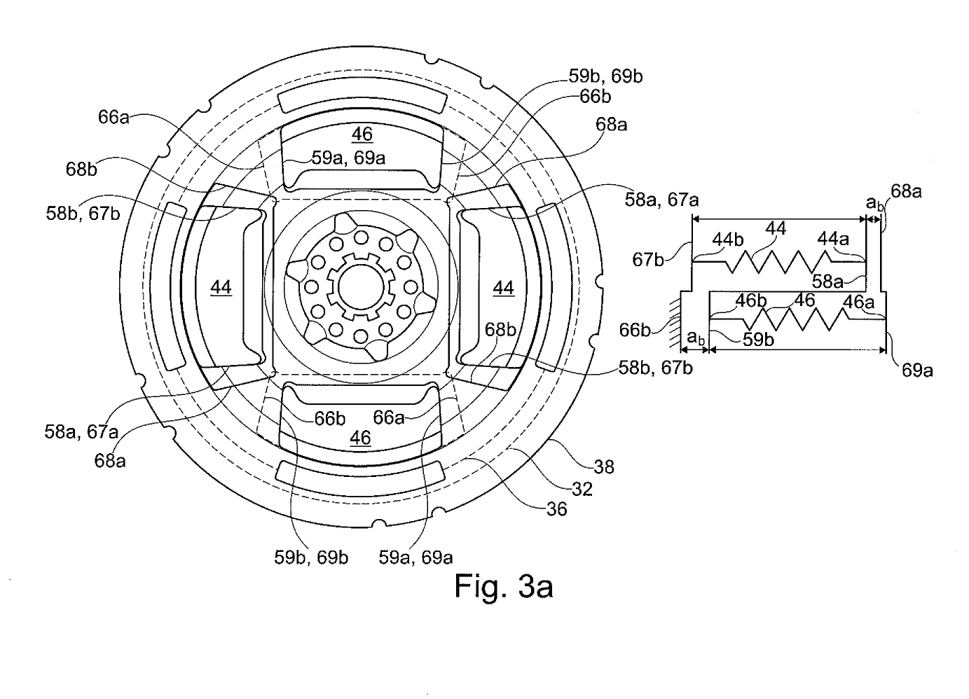

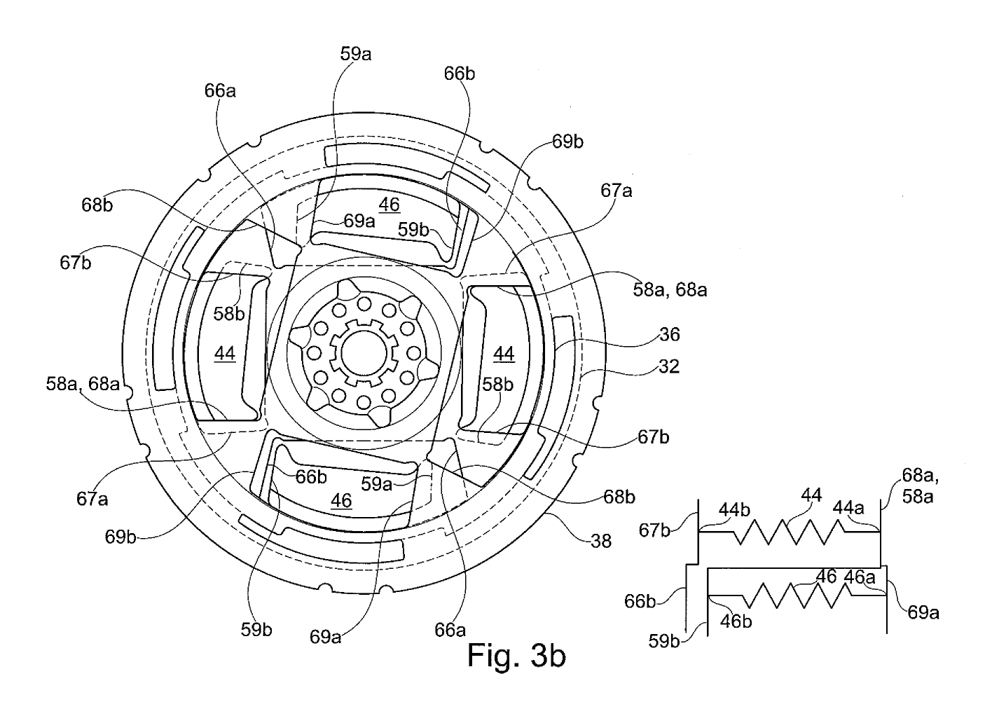

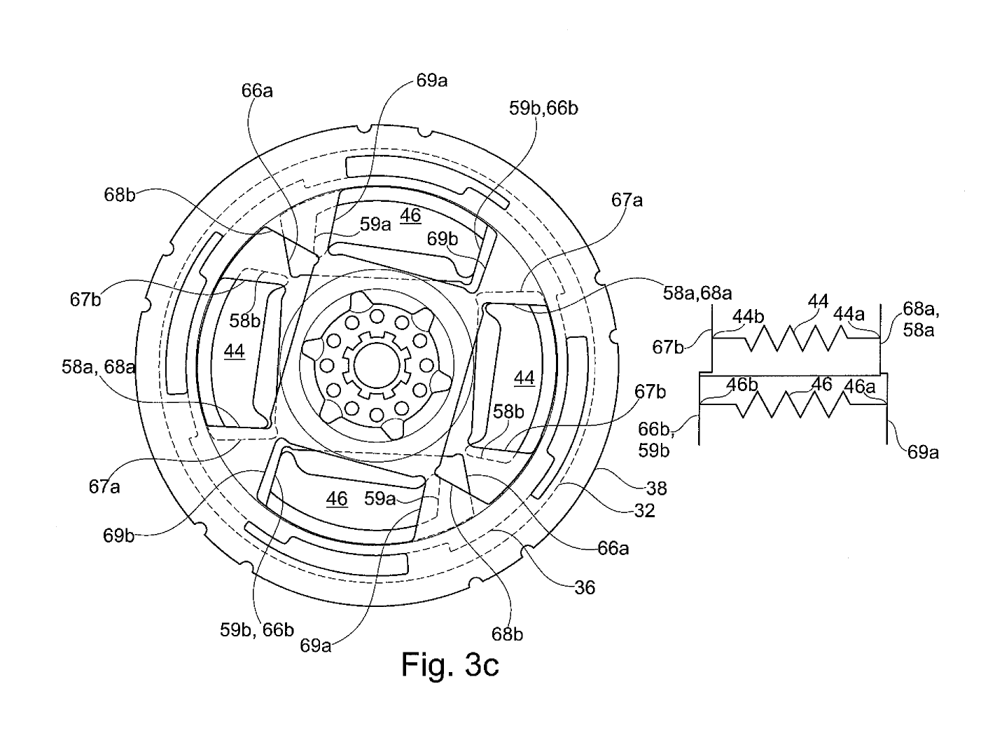

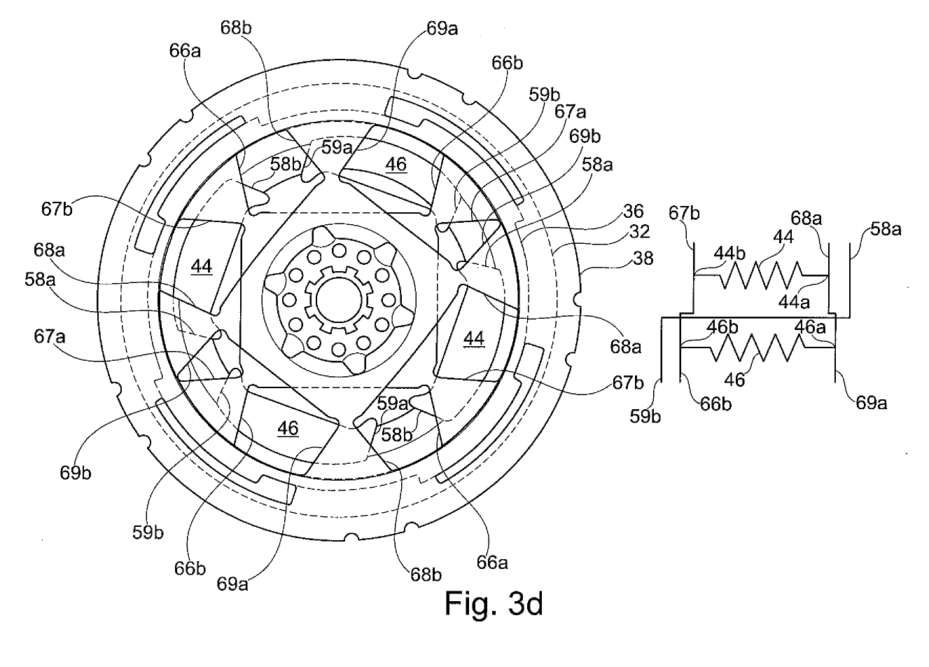

Damper assembly 12 is disposed in an envelope or space 30 formed between turbine 26 and front cover 16. Damper assembly 12 includes a first cover plate 32, a second cover plate 34 connected to first cover plate 32 and also connected to turbine 26, and a first flange 36 and a second flange 38 between cover plates 32, 34. In this embodiment, cover plates 32, 34 are riveted together by rivets 35. Damper assembly 12 includes two spring sets, each including a least one spring. In this embodiment, springs sets include a first spring set including two springs 44 and a second spring set including two springs 46. Springs 44, 46 are held axially between cover plates 32, 34 at the same radial distance such that springs 44, 46 limit the rotation of first flange 36 and second flange 38 with respect to cover plates 32, 34 by circumferentially contacting circumference contact surfaces 66a, 66b, 67a, 67b of flange 36 and contact surfaces 68a, 68b, 69a, 69b of flange 38 (see FIGS. 2a, 2b, 3a to 3d).

First flange 36 includes a substantially flat plate portion 52 and a hub portion 54 protruding axially from plate portion 52. Hub portion 54 is nonrotatably connected to a rotatable input shaft 56 of a transmission, which rotates radially inside of impeller hub 24 about axis A. Second flange 38 is positioned on hub portion 54 such that second flange 38 may move rotationally with respect to first flange 36, as limited by springs 44, 46.

FIGS. 2a and 2b are exploded perspectives view of damper assembly 12. The only difference between FIGS. 2a and 2b is that springs 44, 46 are shown in different places to fully illustrate damper assembly 12, and hub portion 54 is disconnected from and below plate portion 52 of first flange 36. As noted above, damper assembly 12 includes two spring sets including respective springs 44, 46, which alternate circumferentially about axis A. Each cover plate 32, 34 includes four respective slots formed therein - cover plate 32 includes two slots 58, each for receiving one of springs 44, and two slots 59, each for receiving one of springs 46; while cover plate 34 includes two slots 60, each for receiving one of springs 44, and two slots 61, each for receiving one of springs 46. Slots 58 are each defined in cover plate 32 by two respective circumferential contact surfaces 58a, 58b; slots 59 are each defined in cover plate 32 by two respective circumferential contact surfaces 59a, 59b; slots 60 are each defined in cover plate 34 by two respective circumferential contact surfaces 60a, 60b; and slots 61 are each defined in cover plate 34 by two respective circumferential contact surfaces 61a, 61b. Slots 58, 59, 60, 61 may come in and out of contact with corresponding ends 44a, 44b of springs 44 and corresponding ends 46a, 46b of springs 46 during operation of torque converter 10, as further described below with respect to FIGS. 3a to 3d. In this embodiment, slots 58, 60 are all of the same length and slots 59, 61 are all of the same length. Slots 58, 60 may be a different length than or the same length as slots 59, 61.

First flange 36 includes four slots—two slots 66 of a first length for receiving springs 46 and two slots 67 of a second length which is smaller than the first length for receiving springs 44—and second flange 38 also includes four slots—two slots 68 of a third length for receiving springs 44 and two slots 69 of a fourth length smaller than the third length for receiving springs 46. Each slot 66 includes two contact surfaces 66a, 66b for contacting ends 46a, 46b, respectively, of springs 46 and each slot 67 includes two contact surfaces 67a, 67b for contacting ends 44a, 44b, respectively, of springs 44. Similarly, each slot 68 includes two contact surfaces 68a, 68b for contacting ends 44a, 44b, respectively, of springs 44 and each slot 69 includes two contact surfaces 69a, 69b for contacting ends 46a, 46b, respectively, of springs 46. Second flange 38 also includes four slots 70 radially outside of slots 68, 69, through which rivets 35 connecting cover plates 32, 34 to each other pass. Slots 70 are of a length such that rivets 35 can slide circumferentially in slots 70 as second flange 38 rotates relative to cover plates 32, 34. A radial outer surface of second flange 38 further includes indentations 72 therein for radially engaging piston 29. The radial outer surface of second flange 38 extends radially outside of cover plates 32, 34. In this embodiment, slots 67 are of the same length as slots 58, 60 and slots 69 are of the same length as slots 59, 61. Slots 66 may be a different length than or the same length as slots 68.

FIGS. 3a to 3d each show two views illustrating the operation of damper assembly 12. The view of the left is a plan view (springs 44, 46 are omitted, but are identified by their reference numbers 44, 46 and their effect is taken into consideration) of flanges 36, 38 and first cover plate 32 (both cover plates 32, 34 have the same alignment as each other throughout FIGS. 3a to 3d; accordingly, all discussion below of plate 32 also applies to plate 34) and the view on right is a schematic view illustrating movement and compression of one of springs 44 and one of springs 46 in relation to cover plates 32, 34 and flanges 36, 38.

FIG. 3a shows damper assembly 12 in a 0° windup condition. In this condition, first ends 44a and second ends 44b of springs 44 are in contact with both contact surfaces 58a, 58b of both slots 58 of cover plate 32 (and both contact surfaces 60a, 60b of both slots 60 of cover plate 34); first ends 44a and second ends 44b of springs 44 are in contact with both of the contact surfaces 67a, 67b of both slots 67 in first flange 36; and first ends 44a and second ends 44b of springs 44 are spaced away from both of contact surfaces 68a, 68b of slots 68 in second flange 38. Also, first ends 46a and second ends 46b of springs 46 are in contact with both contact surfaces 59a, 59b of both slots 59 of cover plate 32 (and both contact surfaces 61a, 61b of both slots 61 of cover plate 34); first ends 46a and second ends 46b of springs 46 are in contact with both of the contact surfaces 69a, 69b of slots 69 in second flange 38; and first ends 46a and second ends 46b of springs 46 are spaced away from both of contact surfaces 66a, 66b of slots 66 in first flange 36. Accordingly, with respect to springs 44, in the plan view show in FIG. 3a, contact surfaces 67a, 67b of slots 67 are coincident with contact surfaces 58a, 58b of slots 58 and, because slots 68 are longer than slots 58, 67, contact surfaces 68a, 68b of slots 68 are positioned circumferentially outside of contact surfaces 67a, 67b, respectively, of slots 67 and circumferentially outside of contact surfaces 58a, 58b, respectively, of slots 58. Also, with respect to springs 46, in the plan view show in FIG. 3a, contact surfaces 69a, 69b of slots 69 are coincident with contact surfaces 59a, 59b of slots 59 and, because slots 66 are longer than slots 59, 69, contact surfaces 66a, 66b of slots 66 are positioned circumferentially outside of contact surfaces 69a, 69b, respectively, of slots 69 and circumferentially outside of contact surfaces 59a, 59b, respectively, of slots 59.

FIG. 3b shows damper assembly 12 at the end of a first windup stage. In the first windup stage, which occurs between the views of FIGS. 3a and 3b, second flange 38 is rotated clockwise with respect to first flange 36 and cover plate 32 in the plan view shown. During the first windup stage, springs 44 work in series with springs 46 at a reduced spring rate until one of springs 44, 46 comes into contact with both flanges 36, 38. At the end of the first windup stage, each surface 68a of slots 68 in second flange 38 contact the first end 44a of one of springs 44. The rotation of second flange 38 with respect to first flange 36 and cover plate 32 has also caused each contact surface 69a of slots 69 in second flange 38 to move springs 46 such that second end 46b of each spring 46 is closer to corresponding contact surface 66b of slots 66. Additionally, during the first windup stage, the rotation of second flange 38 with respect to cover plate 32 has caused contact surfaces 69a of slots 69 to move ends 46a of springs 46 out of contact with the corresponding contact surfaces 59a of slots 59 in cover plate 32. Accordingly, with respect to springs 44, in the plan view show in FIG. 3b, contact surfaces 58a, 68a of respective slots 58, 67 both contact end 44a of spring 44 and are coincident and 67a is spaced away from end 44a of spring, while only contact surface 67b contacts end 44b of spring 44, contact surface 58b is spaced from end 44b of spring 44 and contact surface 68b is spaced further away from end 44b of spring 44 than contact surface 58b. Also, with respect to springs 46, in the plan view show in FIG. 3b, only contact surface 69a contacts end 46a of spring 46, contact surface 59a is spaced from end 46a of spring 46 and contact surface 66a is spaced further away from end 46a of spring 46 than contact surface 59a, while only contact surface 59b contacts end 46b of spring 46, contact surface 66b is spaced from end 46b of spring 46 and contact surface 69b is spaced further away from end 46b of spring 46 further than contact surface 66b.

FIG. 3c shows damper assembly 12 at the end of a second windup stage. In the second windup stage, which occurs between the views of FIGS. 3b and 3c, second flange 38 is rotated further clockwise with respect to first flange 36 and cover plate 32 in the plan view shown. The second windup stage is the equivalent to the second windup stage of a conventional series damper assembly. This stage only cycles springs 44, via compression by both flanges 36, 38, while springs 46 remains clamped between cover plates 32, 34 and flange 38. This continues until the total damper travel is equal to the distance between contact surface 68a of slot 68 and end 44a of spring 44 aₐ+the distance between contact surface 66b of slot 66 and end 46b of spring 46 a_{b} (see FIG. 3a). It should be noted that if the force required to cycle springs 44 by aₐ is equal to the force required to cycle springs 46 by a_{b}, then the second windup stage is skipped. During the second windup stage, the rotational movement of second flange 38 with respect to first flange 36 and cover plate 32 has caused second flange 38 to compress springs 44, due to the decrease in circumferential distance between surface 68a of each slot 68 and contact surface 67b of each slot 67. At the end of the second windup stage, the end 46b of each spring 46 has contacted surface 66b of the corresponding slot 66. Accordingly, with respect to springs 44, in the plan view show in FIG. 3c, contact surfaces 68a, 58a of respective slots 68, 58 still contact end 44a of spring 44 and are coincident and contact surface 67a of slot 67 is spaced away from end 44a of spring 44, while only contact surface 67b contacts end 44b of spring 44, contact surface 58b is spaced from end 44b of spring 44 and contact surface 68b is spaced further away from end 44b of spring 44 than contact surface 58b. Also, with respect to springs 46, in the plan view show in FIG. 3c, contact surface 69a contacts end 46a of spring 46, contact surface 59a is spaced from end 46a of spring 46 and contact surface 66a is spaced further away from end 46a of spring 46 than contact surface 59a, while contact surfaces 59b, 66b contact end 46b of spring 46 and are coincident with each other and contact surface 69b is spaced away from end 46b of spring 46.

FIG. 3d shows damper assembly 12 at the end of a third windup stage. In the third windup stage, which occurs between the views of FIGS. 3c and 3d, second flange 38 is rotated further clockwise with respect to first flange 36 and cover plate 32 in the plan view shown. In the third windup stage, the damper reaches the travel of aₐ+a_{b} and the torque is calculated both in series and in parallel. The difference between the torque in series and the torque in parallel determines the force/torque required to transition into the third windup stage. During the third windup stage, no force/torque is transmitted through cover plates 32, 34, and springs 44, 46 instead contact directly from flange 36 to flange 38 in parallel arrangement.

During the third windup stage, the rotational movement of second flange 38 with respect to first flange 36 and cover plate 32 has caused second flange 38 to further compress springs 44, due to a further decrease in circumferential distance between surface 68a of each slot 68 and contact surface 67b of each slot 67. The rotational movement of second flange 38 with respect to first flange 36 and cover plate 32 during the third windup stage has also caused second flange 38 to compress springs 46, due to the decrease in circumferential distance between surface 69a of each slot 69 and contact surface 66b of each slot 66. Additionally, during the third windup stage, the rotation of second flange 38 with respect to cover plate 32 has caused contact surfaces 68a of slots 68 to move ends 44a of springs 44 out of contact with the corresponding contact surface 58a of cover plate 32. Accordingly, with respect to springs 44, in the plan view show in FIG. 3d, only contact surface 68a contacts end 44a of spring 44, contact surface 58a is spaced from end 44a of spring 44 and contact surface 67a is spaced further away from end 44a of spring 44 than contact surface 58a, while only contact surface 67b contacts end 44b of spring 44, contact surface 58b is spaced from end 44b of spring 44 and contact surface 68b is spaced further away from end 44b of spring 44 than contact surface 58b. Also, with respect to springs 46, in the plan view show in FIG. 3d, only contact surface 69a contacts end 46a of spring 46, contact surface 59a is spaced from end 46a of spring 46 and contact surface 66a is spaced further away from end 46a of spring 46 than contact surface 59a, while only contact surface 66b contacts end 46b of spring 46, contact surface 59b is spaced from end 46b of spring 46 and contact surface 69b is spaced further away from end 46b of spring 46 than contact surface 59b.

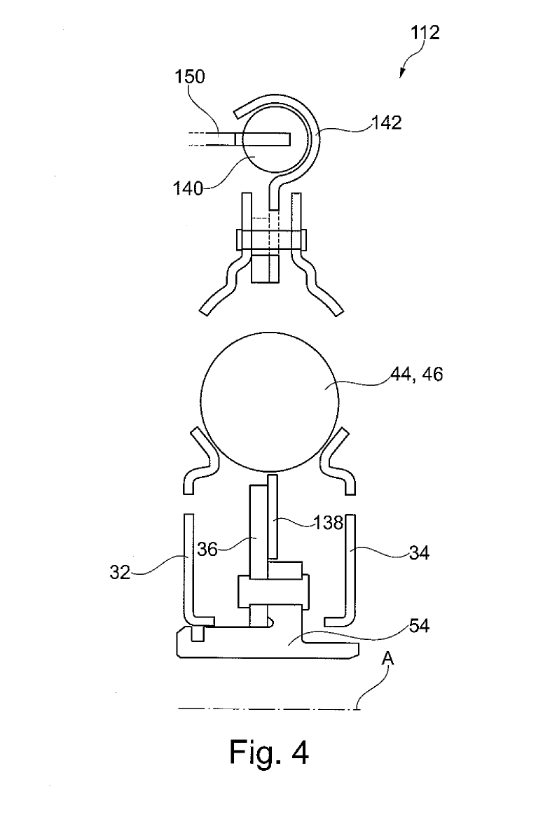

FIG. 4 shows a damper assembly 112 in accordance with another embodiment of the present invention. Damper 112 is formed in substantially the same manner as damper assembly 112, except that springs 44, 46 are used in series with another set of arc springs 140 and flange 38 is replaced by a flange 138 having a spring retainer 142 formed at a radial outer end thereof. Spring retainer 142 retains arc springs 140. A drive portion 150 of a lock up clutch circumferentially engages springs 140. When this configuration is used the preload stage can be eliminated and another useful stage can be added to the damper. In one preferred embodiment, the capacity of the arc springs 140 shown in this design have a capacity equal to the torque required to enter the final stage of the base damper formed by springs 44, 46.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A damper assembly for a torque converter comprising:
a first cover plate;
a second cover plate, the first cover plate and second cover plate supporting springs therebetween,;
a first flange between the first cover plate and the second cover plate; and
a second flange between the first cover plate and the second plate, the first flange and second flange being arranged with respect to the first and second cover plates and the springs such that the springs transition during operation of the damper assembly from initially operating in series to operating in parallel.

2. The damper assembly as recited in claim 1 wherein the springs are at a same radial distance from a center axis of the damper assembly.

3. The damper assembly as recited in claim 1 wherein all of the springs are contacted and compressed by both the first flange and the second flange while operating in parallel.

4. The damper assembly as recited in claim 1 wherein the springs include at least one first spring having a first end held by the first flange and a second end held by at least one of the first cover plate and the second cover plate in a 0° windup condition, the springs including at least one second spring having a first end held by the second flange and a second end held by the at least one of the first cover plate and the second cover plate in a 0° windup condition.

5. The damper assembly as recited in claim 4 wherein at the end of a first windup stage, the second flange contacts the second end of the at least one first spring.

6. The damper assembly as recited in claim 5 wherein the second flange moves the at least one second spring circumferentially towards the first flange between the 0° windup condition and the end of the first windup stage.

7. The damper assembly as recited in claim 5 wherein at the end of a second windup stage, the first flange contacts the second end of the at least one second spring.

8. The damper assembly as recited in claim 7 wherein the second flange compresses the at least one first spring between the end of the first windup stage and the end of the second windup stage.

9. The damper assembly as recited in claim 7 wherein at the end of a third windup stage, the second flange holds the second end of the at least one first spring circumferentially away from the at least one of the first cover plate and the second cover.

10. The damper assembly as recited in claim 9 wherein the first flange and the second flange further compress the at least one first spring between the end of the second windup stage and the end of the third windup stage.

11. The damper assembly as recited in claim 9 wherein at the end of the third windup stage, the first flange holds the second end of the at least one second spring circumferentially away from the at least one of the first cover plate and the second cover plate.

12. The damper assembly as recited in claim 11 wherein the first flange and the second flange compress the at least one second spring between the end of the second windup stage and the end of the third windup stage.

13. The damper assembly as recited in claim 1 wherein the first flange includes at least one first slot of a first length and at least one second slot of a second length greater than the first length, one of the springs being received in the first slot in the first flange and one of the springs being received in the second slot in the first flange.

14. The damper assembly as recited in claim 13 wherein the second flange includes at least one third slot of a third length and at least one fourth slot of a fourth length, one of the springs being received in the third slot in the second flange and one of the springs being received in the fourth slot in the second flange.

15. The damper assembly as recited in 14 wherein the spring received in the first slot is also received in the fourth slot.

16. The damper assembly as recited in claim 15 wherein the spring received in the second slot is also received in the third slot.

17. The damper assembly as recited in claim 1 wherein the torque is input through one of the first flange and the second flange and output through the other of the first flange and the second flange.

18. A torque converter for a motor vehicle drive train comprising:
the damper assembly as recited in claim 1; and
a turbine connected to the damper assembly.

19. The torque converter as recited in claim 18 further comprising a lockup clutch rotationally coupled to the damper assembly.

20. The torque converter as recited in claim 19 wherein the lockup clutch includes a piston, the piston being rotationally connected to the second flange.
